(19) United States
(12) Patent Application Publication
(10) Pub. No.: US 2024/0319681 A1
(43) Pub. Date: Sep. 26, 2024

(54) METHOD FOR CONTROLLING A SYSTEM AND SYSTEM

(71) Applicant: NETZSCH-Gerätebau GmbH, Selb (DE)

(72) Inventors: Martin BRUNNER, Konradsreuth (DE); Thomas DENNER, Selb (DE); Thilo HILPERT, Selb (DE); Fabian WOHLFAHRT, Rehau (DE); Michael SCHÖNEICH, Selb (DE); Michael MÜLLER, Trabitz (DE); Thorsten HACHMANN, Thierstein (DE)

(21) Appl. No.: 18/609,205

(22) Filed: Mar. 19, 2024

Related U.S. Application Data
(60) Provisional application No. 63/453,493, filed on Mar. 21, 2023.

(30) Foreign Application Priority Data
Mar. 21, 2023 (DE) 102023107075.4

(51) Int. Cl. G05B 11/14; G05B 11/32

(52) U.S. Cl. CPC G05B 11/14; G05B 11/32

(57) ABSTRACT

A method for controlling a system having measuring devices includes receiving a request to determine a desired measured value by a controller of the system, creating, by the controller, a proposal as to which of the measuring devices is suitable for determining the specific measured value, and outputting the established proposal to a user of the system by the controller. A system is disclosed including the measuring devices.

### TECHNICAL FIELD

The disclosure herein relates to a method for controlling a system and to a system.

### BACKGROUND

The determination of properties of different materials is of major importance for many applications in research and industry. For this purpose a variety of measuring devices are used which, depending on the application, sometimes provide very complex measuring processes.

Performing these measurements by a user requires a certain level of expertise, since ensuring the successful completion of the desired measurement involves taking into account the technical and scientific background of the individual measurement processes. In addition, there are several measuring devices in most laboratory environments. This means that a user must be familiar with more than one measuring device in order to be able to decide which device is particularly suitable for which measurement. In addition, the measuring devices are generally used by more than one person. They must therefore agree which device is to be used for which measurement at which time.

### SUMMARY

Against this background, it is the object of the disclosure herein to facilitate the use of systems with multiple measuring devices and to make them more efficient.

This problem is solved by a method and by a system having features disclosed herein.

Accordingly, a method for controlling a system with a plurality of measuring devices is provided. The method comprises receiving a request to determine a desired measured value by a controller of the system, creating a proposal by the controller as to which of the plurality of measuring devices is suitable for determining the desired measured value, and outputting the created proposal to a user of the system by the controller.

Furthermore, a system with a plurality of measuring devices is provided, which is configured to perform the method according to the disclosure herein.

It is an underlying idea of the disclosure herein to support the user of the system by a controller designed for this purpose. As the controller communicates a proposal to the user as to which of the plurality of measuring devices is suitable for determining the desired measured value, this step in the measurement preparation can be considerably shortened.

According to an example embodiment of the method, the controller accesses a database when creating the proposal. The creating of a suitable proposal can be advantageously supported by a suitable configuration of the database.

According to a further development of the method, the database comprises a plurality of information about material properties, measurement methods and the plurality of measuring devices, wherein the controller autonomously creates the proposal based on this plurality of information. As a result, the controller can advantageously support a plurality of hypothetically possible measurements.

According to one embodiment of the method, the controller updates the database after the measurement has been performed. As a result, knowledge gained during a measurement can be used to advantage for future measurements.

According to an example embodiment of the method, the proposal comprises a sequential or simultaneous use of a plurality of the plurality of measuring devices. As a result, the workload of the individually measuring devices can be advantageously optimized.

According to an example embodiment of the method, the measurements made by each of the plurality of measuring devices used are taken into account to determine the desired measured value. As a result, determining the desired measured value is simplified.

According to a further development of the method, the determination of the desired measured value is carried out autonomously by the controller. The support provided by the controller can further relieve the user of the system.

According to a further development of the method, the controller takes into account the current or future planned operating states of the plurality of measuring devices while creating the proposal. As a result, the workload of the individually measuring devices can be advantageously optimized.

### BRIEF DESCRIPTION OF THE DRAWINGS

The disclosure herein is explained below with reference to the figures of the drawings. In the figures:

FIG. 1 is a schematic flow diagram for a method according to an example embodiment of the disclosure herein;

FIG. 2 is a schematic representation of a system comprising a plurality of measuring devices according to an example embodiment of the disclosure herein; and

FIG. 3 is a schematic representation of a measuring device according to an example embodiment of the disclosure herein.

In the figures, the same reference signs designate identical or functionally identical components, unless indicated to the contrary.

### DETAILED DESCRIPTION

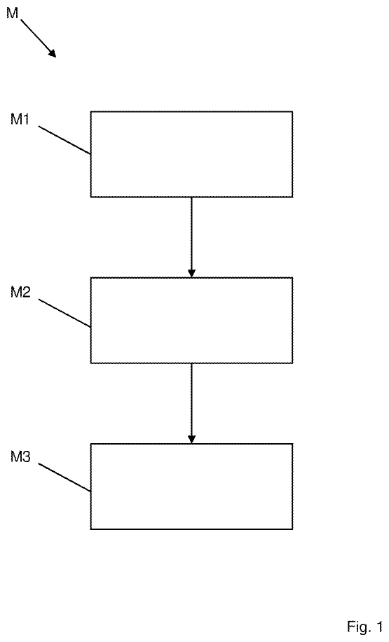

FIG. 1 shows a schematic flow diagram for a method M for controlling a system comprising a plurality of measuring devices according to an example embodiment of the disclosure herein.

In a first method step M1, a controller receives a request to determine a desired measured value. In a further method step M2, the controller creates a proposal as to which of the plurality of measuring devices is suitable for determining the desired measured value. In a further method step M3, the controller outputs the created proposal to a user of the system.

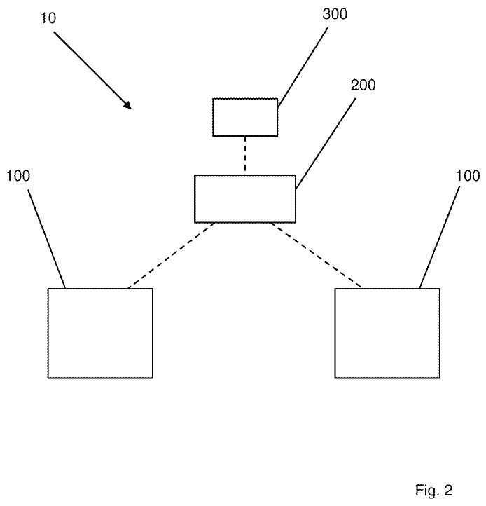

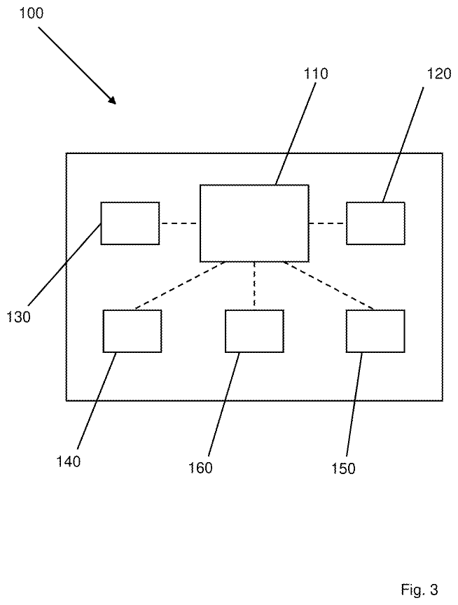

The method M shown is described in detail below with reference to FIGS. 2 and 3.

FIG. 2 shows a schematic representation of a system 10 with a plurality of measuring devices 100 according to an example embodiment of the disclosure herein.

In the example embodiment shown, the system 10 comprises a total of two measuring devices 100, a controller 200 and a database 300.

The controller 200 is configured to receive a request to determine a desired measured value. This request can be made by a user of the system 10, for example, via an inputting device (not explicitly shown) of the controller 200. This inputting device can comprise a keyboard, a touchscreen or similar, for example. Alternatively, the request can also be transmitted to the controller 200 via an external interface.

The controller 200 is further configured to create, in response to the request received, a proposal as to which of the plurality of measuring devices 100 is suitable for determining the desired measured value. For this purpose, the controller 200 can access the database 300. The database 200 may comprise a plurality of information about material properties, measurement methods and the plurality of measuring devices. In this case, the controller 200 autonomously creates the proposal based on this plurality of information. During this process, the controller 200 could possibly also determine that the desired measured value cannot be determined with any of the measuring devices 100. In this case, a corresponding notification can also be outputted instead of a parameter list.

The controller 200 is further configured to output the created proposal to a user of the system 10. For this purpose, for example, there can be used an outputting device (not explicitly shown) of the controller 200. This outputting device can, for example, comprise a screen and/or speakers. For example, the outputting device and the inputting device of the controller 200 can also be combined in a touchscreen. Alternatively or additionally, individual components of the measuring devices 100 can also be highlighted, for example by illuminating switch panels or the like that are to be actuated.

In particular, the controller 200 may also be configured to update the database 300 after the specific measurement has been performed. The measurement results relating to the material properties of the sample used in the measurement can then be recorded in the database 300, for example, and are then available for future measurements and measurement schedules. Predetermined measurement schedules can also be revised, taking into account the measurement carried out. The information required for this regarding the measurement performed can either be transmitted from a user system 10 to the controller 200. Alternatively or additionally, the controller 200 can also receive the relevant information directly from the measuring devices 100.

The proposal created by the controller 200 may comprise sequential or simultaneous use of a plurality of the plurality of measuring devices. This can be advantageous if, for example, the desired measured value is to be determined several times for reasons of repeatability or if several different measuring processes have to be performed to determine the desired measured value in order to determine intermediate results from which the desired measured value is to be indirectly derived. In such a case, it may be provided that the measurements taken by each of the plurality of measuring devices 100 used are taken into account for determining the desired measured value. In this case, determining the desired measured value can be carried out autonomously by the controller 200.

The controller 200 may also be configured to take into account the current or future planned operating states of the plurality of measuring devices while creating the proposal. For example, one of the measuring devices 100 may be proposed, even if another of the measuring devices 100 would in principle be better suited for determining the desired measured value, if this other measuring device 100 is already intended for other measuring processes in the foreseeable future.

FIG. 2 shows two measuring devices 100. However, there can actually be provided any number of measuring devices 100. The measuring devices 100 can be configured to have the same function or be configured to perform different measurements in each case. Depending on the application, this allows the respective measurement processes to be performed simultaneously or sequentially. In particular, the measuring devices 100 may be configured as devices for the thermal analysis of materials. In particular, the measuring devices 100 may be configured for performing differential thermal analyses, dynamic differential calometry, dynamic mechanical analyses, thermomechanical analyses or the like. During such measuring processes, the support of a user by the controller 200 can be particularly advantageous.

The database 300 is shown here as a specific component of the system 10. However, it is also conceivable that the controller 200 and/or the database 300 is connected to an extended network, in particular to the Internet, and obtains relevant information directly via this network instead of storing it locally.

FIG. 3 shows a schematic representation of a measuring device 100, which may be provided in a system according to an example embodiment of the disclosure herein.

The measuring device 100 comprises a controller 110, a database 120, a sensor device 130, an outputting device 140, an inputting device 150, and a sample receiving device 160.

The controller 110 may be configured to communicate with a controller 200 of the higher-level system 10 and to implement the proposals and the like determined by the controller 200 of the system 10 directly at the measuring device 100. For this purpose, the controller 110 can access a database 120 integrated in the measuring device 100, on which information relevant to the measuring device 120 can be stored. In principle, the controller 110 and the database 120 of the measuring device can have the same functionalities as the corresponding components of the higher-level system 10 and support them.

The sensor device 130 can be configured to monitor measurement parameters while determining the measured value. In this case, the controller 110 can be configured to evaluate the monitored measurement parameters. This can enable the controller 110 to output a warning, interrupt the determining of the measured value, or autonomously change the parameters of the measuring device 100 if this should be necessary when determining the desired measured value.

The outputting device 140 may comprise, for example, a screen and/or speakers. The inputting device 150 may comprise, for example, a keyboard, a touch screen or the like. For example, the outputting device 140 and the inputting device 150 may also be combined in a touchscreen. Individually components of the measuring device 100, such as the inputting device 150 and the sample receiving device 160, can be configured to be highlighted, for example by illuminating switch fields to be actuated or the like.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.
100 measuring device
110 controller
120 database
130 sensor device
140 outputting device
150 inputting device
160 sample receiving device
200 controller
300 database
M method
M1 method step
M2 method step
M3 method step

1. A method for controlling a system having a plurality of measuring devices, comprising:
receiving a request to determine a desired measured value by the controller of the system;
creating, by the controller, a proposal as to which of the plurality of measuring devices is suitable for determining the specific measured value; and
outputting the created proposal to a user of the system by the controller.

2. The method according to claim 1, wherein the controller accesses a database for creating the proposal.

3. The method according to claim 2, wherein the database comprises a plurality of information regarding material properties, measurement methods and the plurality of measuring devices, and the controller autonomously creates the proposal based on the plurality of information.

4. The method according to claim 2, wherein the controller updates the database after determining the measured value.

5. The method according to claim 1, wherein creating proposal comprises a sequential or simultaneous use of a plurality of the plurality of measuring devices.

6. The method according to claim 5, wherein for a determination of the desired measured value, the measurements made by each of the plurality of measuring devices used is taken into account.

7. The method according to claim 6, wherein determining the desired measured value is carried out autonomously by the controller.

8. The method according to claim 1, wherein the controller takes into account a current or future planned operating states of the plurality of measuring devices for creating the proposal.

9. A system comprising a plurality of measuring devices configured to perform the method according claim 1.
